(19) United States
(12) Patent Application Publication
(10) Pub. No.: US 2009/0049294 A1
(43) Pub. Date: Feb. 19, 2009

(54) METHOD FOR BOOTING COMPUTER SYSTEM

(75) Inventors: Chin-Yu Wang, Taipei (TW); Hsien-Shan Wang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/190,574

(22) Filed: Aug. 12, 2008

(30) Foreign Application Priority Data
Aug. 13, 2007 (TW) 96129833

(51) Int. Cl. G06F 15/177

(52) U.S. Cl. 713/2; 713/100

(57) ABSTRACT

The invention relates to a method for booting a computer system. The method includes the steps of executing a hardware initialization process, starting a setting interface according to a trigger signal, determining whether a specific setting option belongs to a specific option group when the value of the specific setting option in the setting interface is changed and loading an operating system to the computer system when the specific setting option belongs to the specific option group.

### CROSS-REFERENCE TO RELATED APPLICATION

This application claims the priority benefit of Taiwan application serial no. 96129833, filed on Aug. 13, 2007. The entirety of the above-mentioned patent application is hereby incorporated by reference herein and made a part of specification.

### BACKGROUND OF THE INVENTION

1. Field of the Invention

The invention relates to a method for booting a computer system and, more particularly, to a method for booting a computer system when a setting option is changed.

2. Description of the Related Art

In the configuration of a computer system, a basic input output system (BIOS) is basic software for basic operation of the computer system. The BIOS is mostly composed of a series of low level instruction sets and is in charge of initializing basic hardware, defining features of the computer system and processing basic work when the computer system is operated. For example, during the boot process of the computer, the BIOS can detect or set the peripheral hardware devices such as a hard disk, a keyboard and a connection port.

To allow a user to change the setting of some hardware of the computer system, suppliers that provide BIOS image files utilize a utility to allow the computer system to enter the setting picture of the BIOS when the user presses the hot key (such as the DEL or F8 key) on a keyboard after the computer system is booted. After the computer system enters the setting picture, the user can change the system time, the password and the speed of the boot disk or the processor. After the setting of the BIOS is changed, the computer system may quit the setting picture of the BIOS. Afterwards, the computer system is rebooted.

In the method for changing the setting of the BIOS, every time the user changes the setting options of the BIOS, he needs to wait for the computer system to reboot, which wastes the time. Furthermore, in the method for changing the setting of the BIOS, as long as the computer system enters the setting picture of the BIOS, no matter the user changes the setting of the BIOS or not, the computer system needs to be rebooted when the computer system quits the setting picture of the BIOS, which wastes the user's time on the rebooting process of the computer system.

### BRIEF SUMMARY OF THE INVENTION

The invention provides a method for booting a computer system to decrease the time for waiting for the computer system to reboot.

The invention provides a method for booting a computer system, and the method includes the following steps. A hardware initialization process is executed. Next, a setting interface is started according to a trigger signal, and the setting interface includes a plurality of setting options. Then, when the value of a specific setting option in the setting options is changed, whether the specific setting option belongs to a specific option group is determined. Finally, an operating system is loaded when the specific setting options (that are changed) belong to the specific option group.

In one embodiment of the invention, when the specific setting option (any one that is changed) does not belong to the specific option group, the computer system is rebooted, and the hardware initialization process is executed.

In one embodiment of the invention, before the step of loading the operating system, the method further includes the step of executing a peripheral component initialization program. After the setting interface is started, the method further includes the step of adjusting the value of the setting option.

In one embodiment of the invention, the method further includes the step of determining whether to store the values of the adjusted setting options. When the values of the adjusted setting options are determined not to be stored, the computer system quits the setting interface, a peripheral component initialization program is executed, and the operating system is loaded. When the values of the adjusted setting options are determined to be stored, the values of the adjusted setting options are stored to a memory unit, and the computer system quits the setting interface.

In one embodiment of the invention, the method further includes the steps of receiving a trigger signal and setting a flag according to the trigger signal. After the hardware initialization process is executed, whether the flag is set is checked. When the flag is set, the computer system enters the setting interface. When the flag is not set, the peripheral component initialization program is executed, and the operating system is loaded.

In one embodiment of the invention, the method further includes the step of building a specific option group table. The specific option group table includes a plurality of columns for recording a plurality of non-rebooting options. The specific option group is the assembly of the non-rebooting options. The step of determining whether the specific setting option belongs to the specific option group includes the step of determining whether the specific setting option is one of the non-rebooting options recorded in the specific option group table.

In one embodiment of the invention, the step of executing the hardware initialization process includes the steps of initializing a central processing unit (CPU), detecting a memory, testing a chip set, initializing a keyboard controller and initializing a display unit.

In the invention, when the value of a specific setting option in the setting interface is changed, whether to reboot the computer system is determined according to whether the specific setting option belongs to the specific option group. Therefore, the user may not need to wait for the computer to reboot every time he changes the setting.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a flow chart showing a method for booting a computer system according to the first embodiment of the invention.

FIG. 2 is a flow chart showing a method for booting a computer system according to the second embodiment of the invention.

FIG. 3 is a schematic diagram showing a specific option group table according to the second embodiment of the invention.

### DETAILED DESCRIPTION OF THE EMBODIMENTS

### First Embodiment

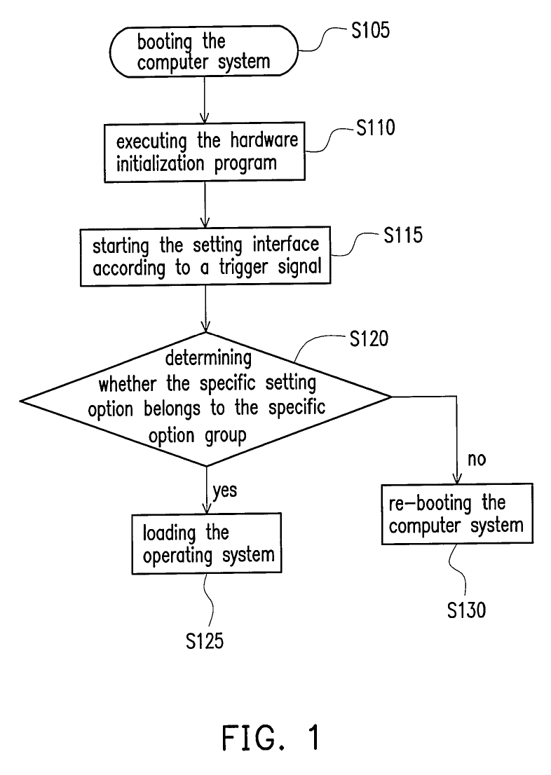

FIG. 1 is a flow chart showing a method for booting a computer system according to the first embodiment of the invention. As shown in FIG. 1, first, the computer system is booted (the step S105). That is, when a user presses a power button of the computer system, the computer system is booted. Next, the computer system executes a hardware initialization process (the step S110) to initialize the hardware in the computer system. Taking a conventional computer system as an example, after the computer system is booted, a basic input output system (BIOS) begins to initialize and test the hardware in the computer system.

At that moment, if a user wants to change the setting of the hardware in the computer system, he needs to press a hot key such as a Delete key or a F8 key on a keyboard to enter the setting interface of the BIOS. Therefore, after the step S110 is executed, the computer system starts a setting interface (the step S115) according to a trigger signal (generated by the pressed hot key).

After the computer system enters the setting interface, the user can change the values of the setting options in the setting interface. The setting options may be, for example, the system time, the user password, the administrator password, a boot sequence and so on. Afterwards, the user chooses to quit the setting interface. In the embodiment, after the computer system quits the setting interface, when the value of any specific setting option in the setting options is changed, the computer system determines whether the changed specific setting option belongs to a specific option group (the step S120). In the embodiment, the specific option group may, for example, consist of the non-rebooting setting options of the setting options, and the non-rebooting setting options have nothing to do with the completed boot process of the computer. That is, after the user changes the non-rebooting setting options, the computer system loads the operating system without re-booting the computer.

Therefore, in the step S120, if the specific setting options (all the changed) belong to the specific option group, the computer system loads the operating system (the step S125). Afterwards, the computer system enters a common normal operating mode. For example, if the specific setting option changed by the user in the setting interface is the user password, the setting option has nothing to do with the boot process. Therefore, after the computer system quits the setting interface, the operating system is directly loaded without re-booting the computer. In the step S125, assuming that each hardware is initialized and tested before the computer system enters the setting interface, the operating system can be directly loaded. However, if only part of the hardware is initialized and tested before the computer system enters the setting interface, in the step S125, the computer system continues to initialize and test the hardware that is not initialized and tested before the computer system enters the setting interface. Then, the computer system loads the operating system.

In the step S120, if the specific setting option (any one that is changed) does not belong to the specific option group, the computer system is re-booted (the step S130) and re-executes the hardware initialization process. For example, if the specific setting option changed by the user in the setting interface is the frequency of the CPU, the specific setting option is relative to the initialization of the CPU during the boot process. Therefore, after the computer system quits the setting interface, the computer system is re-booted to initialize the CPU again. Furthermore, in the embodiment, the computer system may be re-booted in a conventional warm boot mode.

In the embodiment, the specific option group may consist of, for example, a plurality of non-rebooting setting options in the setting options. However, persons having ordinary skill in the art should know that the specific option group also may consist of, for example, the rebooting setting options. Therefore, in the step S120, if the specific setting option (any one) belongs to the specific option group, the computer system is rebooted; otherwise, if the specific setting options (all the changed) do not belong to the specific option group, the computer system loads the operating system.

To sum up, in the embodiment, after the setting options in the setting interface are changed, whether the changed setting options belong to the specific option group is determined to determine when the computer system needs to be rebooted, thereby reducing the time for waiting for the computer system to reboot. To make the spirit of the invention better understood, the second embodiment is illustrated hereinbelow.

### Second Embodiment

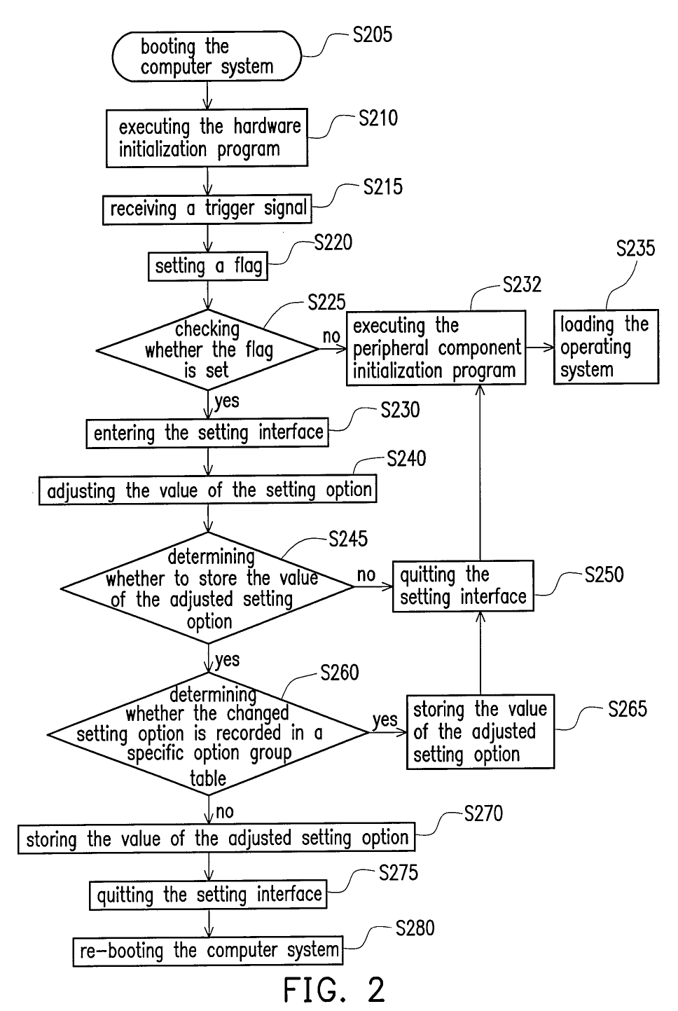

FIG. 2 is a flow chart showing a method for booting a computer system according to the second embodiment of the invention. As shown in FIG. 2, first, the computer system is booted (the step S205). That is, when the user presses the power button of the computer system, the computer system is booted. Afterwards, the computer system executes a hardware initialization process (the step S210) to initialize the hardware in the computer system. Taking a conventional computer system as an example, after the computer system is booted, the whole computer system is controlled by the BIOS. The BIOS begins to initialize and test the hardware in the computer system.

Afterwards, if the user wants to change the setting of some hardware in the computer, he presses the hot key on the keyboard, and then the computer system enters the setting interface of the BIOS. At that moment, the computer system receives a trigger signal transmitted from the hot key (the step S215). Next, the computer system sets a flag according to the trigger signal (the step S220). The BIOS checks whether a flag is set (the step S225) after completing the hardware initialization process. After the BIOS completes the hardware initialization process, the CPU, the south and north bridge chip sets, the memory, the display device (such as the graphics chip or the graphics card) and the input output device (such as the keyboard) in the computer system are initialized and can be normally used. Then, the BIOS checks the flag to allow the user to enter the setting interface of the BIOS, and therefore, the user can change the setting options of the BIOS via the input output device and the display device.

In the step S225, if the BIOS determines that the flag is set, which means the user wants to enter the setting interface to change the setting of the hardware, the BIOS enters the setting interface (the step S230). On the contrary, if the BIOS determines that the flag is not set, the BIOS executes a peripheral component initialization program (the step S232). That is, the hardware that is not initialized by the hardware initialization process is initialized. Next, the BIOS loads the operating system (the step S235) to allow the operating system to control the computer system.

After the BIOS enters the setting interface, the values of the setting options in the setting interface can be adjusted by the user (the step S240). After the user adjusts the setting options, he chooses to quit the setting interface. At that moment, the BIOS allows a window to be shown to prompt the user to save the values of the adjusted setting options (the step S245). If the user does not save the values of the adjusted setting options, the BIOS quits the setting interface (the step S250), executes the peripheral component initialization program (the step S232) and loads the operating system (the step S235) to allow the operating system to control the computer system.

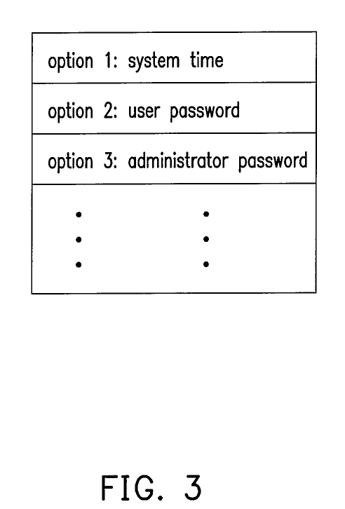

If the user chooses to store the values of the adjusted setting options, the BIOS determines whether the adjusted setting options are recorded in a specific option group table (the step S260). In the embodiment, the specific option group table may be a table that is pre-defined by the BIOS, as shown in FIG. 3. FIG. 3 is a schematic diagram showing a specific option group table according to the second embodiment of the invention. As shown in FIG. 3, the specific option group table includes a plurality of columns for recording non-rebooting options such as the system time option, the user password option or the administrator password option whose change do not affect the boot process, respectively. Herein, the specific option group in the first embodiment may be the assembly of the non-rebooting options in FIG. 3.

In the step S260, if the BIOS determines that the changed setting options are recorded in the specific option group table, which means that the setting options changed by the user cannot affect the boot process. Therefore, the BIOS stores the values of the adjusted setting options to a memory unit (the step S265). The memory unit may be a CMOS memory or a flash memory in the computer system. Afterwards, the BIOS quits the setting interface (the step S250), executes the peripheral component initialization program (the step S232) and loads the operating system (the step S235) to allow the operating system to control the computer system. For example, if the specific setting option changed by the user in the setting interface is the user password option, the changed setting option is the option recorded in the second column of the specific option group table in FIG. 3. Therefore, the BIOS determines that the setting option changed by the user has nothing to do with the boot process, and then it continues to execute the peripheral component initialization program and begins to load the operating system.

In the step S260, if the BIOS determines that the changed setting options are not recorded in the specific option group table, which means the setting options changed by the user can affect the boot process. Therefore, the BIOS stores the values of the adjusted setting options to the memory unit (the step S270), quits the setting interface (the step S275) and reboots the computer system (the step S280).

In the embodiment, each column of the specific option group table in FIG. 3 may be used to record, for example, the non-rebooting setting option. However, persons having ordinary skill in the art should know that each column of the specific option group table in FIG. 3 also may be used to store, for example, the rebooting option. Therefore, in the step S126, if the changed setting option is determined to be recorded in the specific option group table, the BIOS reboots the computer system; otherwise, if the changed setting option is determined not to be recorded in the specific option group table, the BIOS continues to execute the peripheral component initialization program and loads the operating system.

In the embodiment, the hardware initialization process in the step S210 and the peripheral component initialization program in the step S232 are not precisely defined, and they are used to initialize or test the hardware of the computer system before the BIOS enters the setting interface or after the BIOS enters the setting interface, respectively. Taking a conventional BIOS as an example, the BIOS initializes and tests the CPU, the random access memory, the south and north bridge chip sets, the display unit and the keyboard controller before it enters the setting interface, and then the above hardware components can be normally operated. Afterwards, the BIOS checks the flag to determine whether to enter the setting interface. That is, the hardware initialization process may be used to initialize part of the hardware devices of the computer system. Furthermore, the BIOS also can check the flag after all the hardware of the computer system is initialized and tested to determine whether to enter the setting interface. That is, the above hardware initialization process is used to initialize all the hardware of the computer system.

In the invention, after the setting options changed by the user are determined to have nothing to do with the boot process, the computer does not need to be rebooted, thereby saving the time for re-executing the hardware initialization process by the BIOS. After the computer system quits the setting interface, the BIOS only needs to execute the peripheral component initialization program (to initialize the hardware that is not initialized by the hardware initialization process), and then the operating system is loaded. If the BIOS initializes all hardware of the computer system when it executes the hardware initialization process, it loads the operating system without executing the peripheral component initialization program.

In the embodiment, in the steps S265 and S270, the values of the adjusted setting options are stored. Persons having ordinary skill in the art should know that the steps S265 and S270 can be integrated into one step, and the step S265 (or the step S270) is executed after the values of the setting options are determined to be stored. Afterwards, the step S260 is executed. That is, whether the changed setting options are recorded in the specific option group table is determined.

To sum up, the method for booting the computer system of the invention determines whether the computer system needs to be rebooted according to whether the changed setting options belong to the specific option group or whether the changed setting options are recorded in the specific option group table. Therefore, the time for rebooting and re-testing and re-initializing the hardware is saved after the user changes the setting.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for booting a computer system, the method comprising the steps of:
executing a hardware initialization process;
starting a setting interface according to a trigger signal, wherein the setting interface comprises a plurality of setting options;
determining whether at least one specific setting option belongs to a specific option group when the value of the specific setting options in the setting options is changed; and
loading an operating system when those specific setting options belong to the specific option group.

2. The method for booting the computer system according to claim 1, wherein before the step of loading the operating system, the method further comprises the step of executing a peripheral component initialization program.

3. The method for booting the computer system according to claim 1, wherein after the step of starting the setting interface, the method further comprises the step of adjusting values of the setting options.

4. The method for booting the computer system according to claim 3, further comprising the steps of:
determining whether to store the values of the adjusted setting options;
quitting the setting interface and loading the operating system when the values of the adjusted setting options are determined not to be stored; and
storing the values of the adjusted setting options to a memory unit and quitting the setting interface when the values of the adjusted setting options are determined to be stored.

5. The method for booting the computer system according to claim 4, wherein before the step of loading the operating system, the method further comprises the step of executing a peripheral component initialization program.

6. The method for booting the computer system according to claim 1 further comprising the step of setting a flag according to the trigger signal.

7. The method for booting the computer system according to claim 6, wherein after the step of executing the hardware initialization process, the method further comprises the steps of:
checking whether the flag is set;
entering the setting interface when the flag is set; and
loading the operating system when the flag is not set.

8. The method for booting the computer system according to claim 7, wherein before the step of loading the operating system, the method further comprises the step of executing a peripheral component initialization program.

9. The method for booting the computer system according to claim 1, the method further comprising the step of:
building a specific option group table, wherein the specific option group table comprises a plurality of columns for recording a plurality of non-rebooting options, and the specific option group is the assembly of the non-rebooting options.

10. The method for booting the computer system according to claim 9, wherein the step of determining whether the specific setting option belongs to the specific option group comprises the step of determining whether the specific setting option is one of the non-rebooting options recorded in the specific option group table.

11. The method for booting the computer system according to claim 1, wherein the step of executing the hardware initialization process comprises the steps of:
initializing a central processing unit (CPU);
detecting a memory;
testing a chip set;
initializing a keyboard controller; and
initializing a display unit.
